(19) United States
(12) Patent Application Publication
(10) Pub. No.: US 2018/0263195 A1
(43) Pub. Date: Sep. 20, 2018

(54) Under Flow Air System for Agriculture

(71) Applicant: Horticultural Solutions Ltd., Wheat Ridge, CO (US)

(72) Inventor: Shane Hutto, Idaho Springs, CO (US)

(73) Assignee: Horticultural Solutions Ltd., Wheat Ridge, CO (US)

(21) Appl. No.: 15/921,021

(22) Filed: Mar. 14, 2018

Related U.S. Application Data
(60) Provisional application No. 62/470,982, filed on Mar. 14, 2017.

(51) Int. Cl. A01G 9/26; A01G 22/00; A01G 7/06; F04D 29/54; F04D 29/02

(52) U.S. Cl. CPC A01G 9/26; A01G 22/00; F04D 25/08; F04D 29/545; F04D 29/023; A01G 7/06

(57) ABSTRACT

A system for promoting airflow beneath a plant canopy in a plant husbandry facility includes fan that creates airflow therethrough and a duct row in fluid communication with the fan, wherein the duct row has holes therein, wherein the holes are oriented to direct airflow from the fan out of the holes and beneath the plant canopy.

### BACKGROUND

Greenhouses, indoor growing facilities, or plant husbandry facilities (as they will be called herein) allow for and encourage plant growth without seasonal interruption. Plant husbandry facilities also give a horticulturalist control over the environment, which increases crop yield per area. And in the growing field of cannabis production, plant husbandry facilities capture odors that neighbors sometimes find undesirable.

Plant husbandry facilities, however, introduce their own challenges. For example, the closed, high humidity, low air circulation environment in a plant husbandry facility gives rise to a higher occurrence of certain plant diseases, molds, and other undesirable pestilence than might be found in nature: Rhizoctonia target spot, Rhizoctonia stem rot, Sclerotinia stem rot, Pythium root rot, bacterial soft rot, Botrytis gray mold, black root rot, anthracnose, black shank, and Granville wilt are common. The environment also may give rise to soil-borne diseases such as Granville wilt and black shank—the concern with these is that the soil-borne diseases may transfer to future plants. The combination of all of the above diseases may cause as much as 30% crop loss.

A good plant husbandry facility does what it can to overcome disease and mold. Solutions to address these include increased airflow using fans, elevated growing tables, access to light, air and water purification, and soil treatment. All of these help, but some areas of a plant, especially its canopy's underside (FIG. 1, 90) and roots are hard to access due to the natural light and air sheltering by the canopy itself and the soil cover.

The system described herein seeks to address the above challenges.

### SUMMARY OF THE EMBODIMENTS

A system for promoting airflow beneath a plant canopy in a plant husbandry facility includes fan that creates airflow therethrough and a duct row in fluid communication with the fan, wherein the duct row has holes therein, wherein the holes are oriented to direct airflow from the fan out of the holes and beneath the plant canopy.

### BRIEF DESCRIPTION OF THE DRAWINGS

FIG. 1 shows a perspective view of the underflow system.

FIG. 2 shows a manifold of the system.

FIG. 3 shows a top view of the system.

FIG. 4. Shows an end view of the system.

### DETAILED DESCRIPTION OF THE EMBODIMENTS

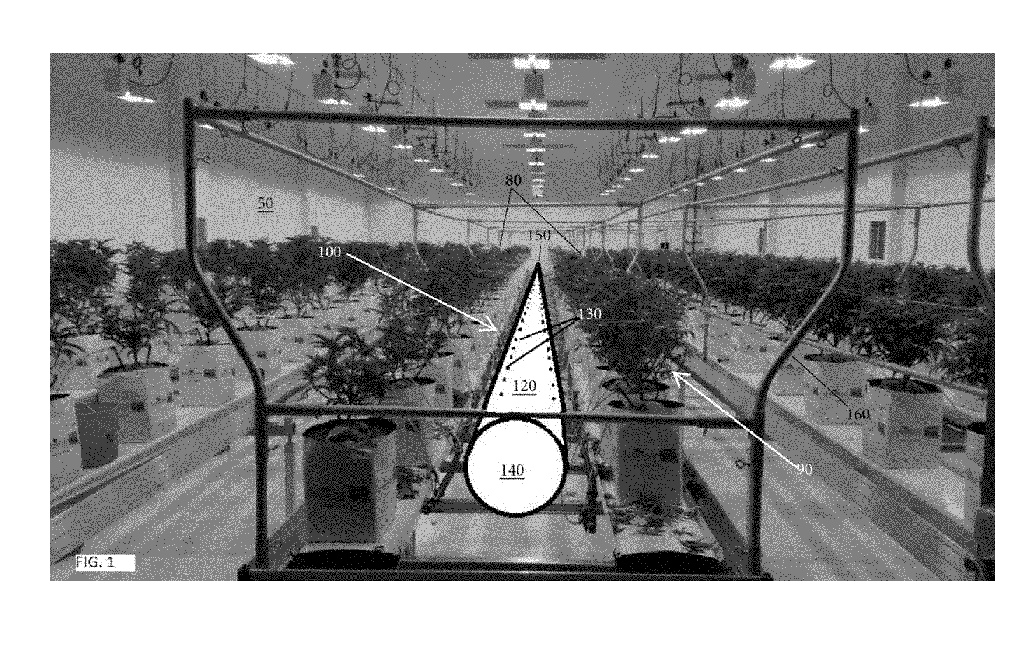

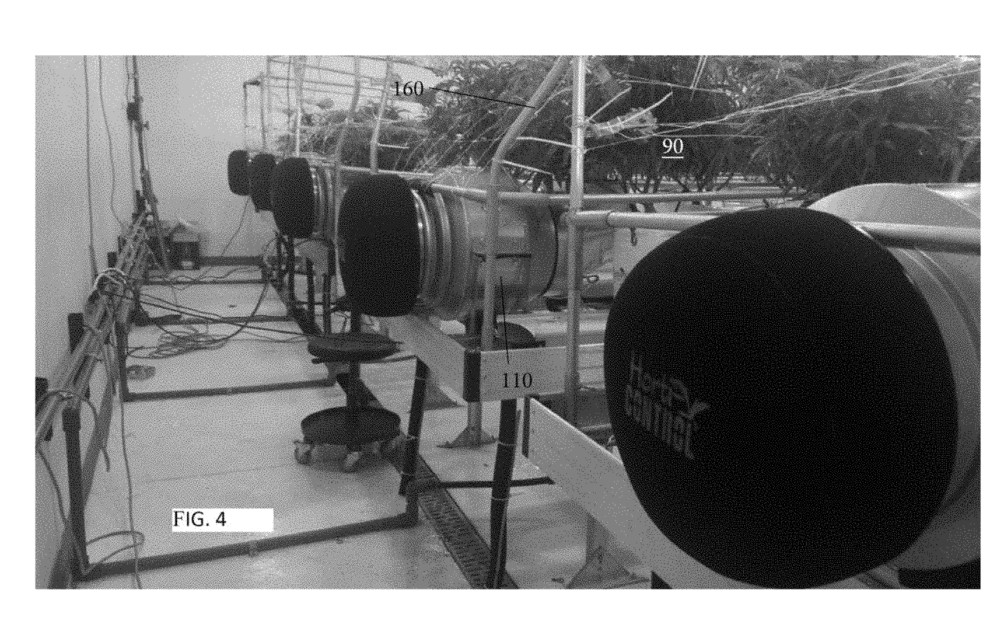

As shown in FIGS. 1-4, the system 100 described herein is an underflow air system that directs air upwards into the canopy 90, and optionally also across or into the plant root system. The system 100 includes at a minimum, a fan 110 in fluid communication with a duct/tube run 120 having vent holes 130.

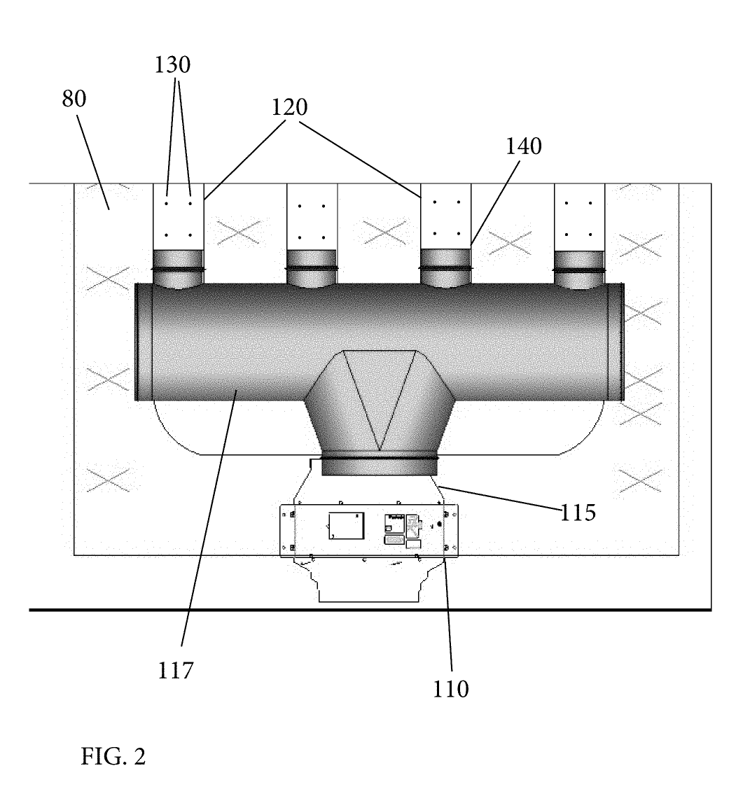

When set up inside a plant husbandry facility 50, duct runs 120 may be located between adjacent plant rows 80. Although FIG. 1 shows only one duct row 120, it should be appreciated that as shown in FIG. 2, multiple duct rows 120 are possible. The duct rows 120 may be straight as shown, and this is likely ideal to ensure airflow, but it is not required and other patterns are possible.

The duct rows 120 may be located below the plant canopy 90, and situated such that the vent holes 130 are aligned upwards into the canopy 90. The duct rows 120 may also be aligned level with the canopy 90 or in other orientations as long as vent holes 130 are aligned to direct airflow under the canopy 90. For example, with plants that have root issues, the duct rows 120 may also be aligned such that the vent holes 130 better aerate a root system.

In the single duct run 120 in FIG. 1, the holes 130 are aligned at approximately 11 and 1 on a clock face. The holes 130 may be preset, customizable, or even adjustable. Adjustability may be achieved using a multi-layered duct run 120, where an inner layer has duct holes 130 and an outer layer of duct run 120 has multiple holes 130 that can be aligned over one another to allow airflow, or not, according to a plant husbandry facility's needs. Customizing the orientation may be needed for facilities where the duct run 120 may need different orientation to align under the canopy 90.

The vent holes 130 may be cut, punched, heat stamped or formed according to any other manner that allows passage for airflow.

The duct run 120 has a first end 140 and a second end 150. The first end 140 is closer to the fan 110 that provides the circulating air within the system 100, and the second end 150 is at the terminal end of the duct run 120. The second end 150 may be closed, have openings, or may have adjustable openings to allow adjustment of air speed through the vent holes 130.

The duct run 120 may be made from 4 mm thick to thicker polyethylene, which allows for easy installation, repair (duct tape or similar adhesive tape), and inexpensive disposal and replacement at the end of a growing season. The duct run 120 may have an outer diameter of 6-36 inches, depending on the needs of a plant husbandry facility.

Scaffolding 160 and wiring may be used to orient and support the fan 110 and duct runs 120. Other support systems may be used as well depending on space availability and height of the plant canopy 90.

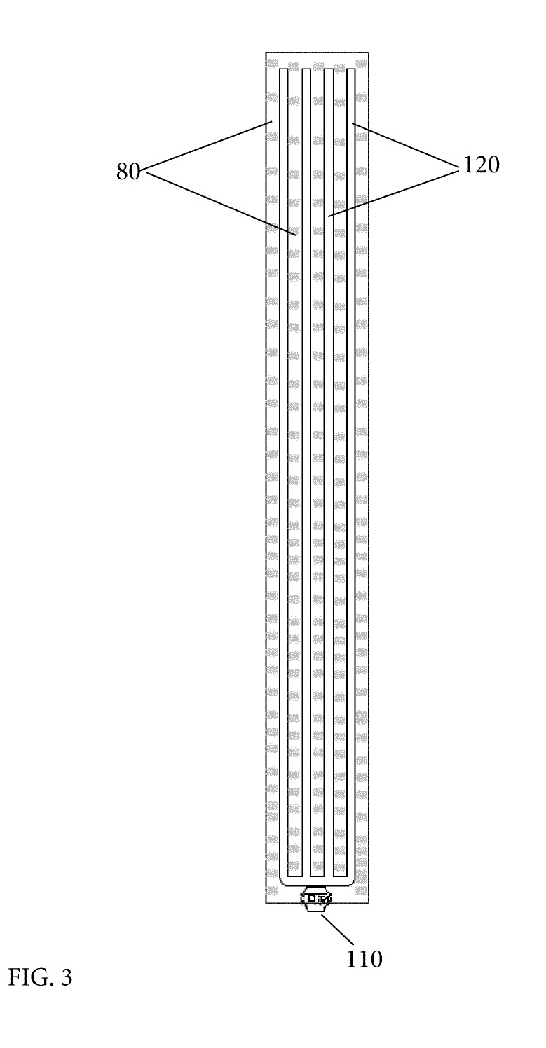

The fan 110 that drives air through the duct run(s) 120 may be a 12 inch 2000 cfm fan 9 (larger fans with more cfm capacity may be used depending on the size of the facility). During installation, the fan 110 size may be reduced through a reducer 115 to 8 inches. For plant husbandry facilities where multiple runs would be advantageous, the fan 110 or reducer 115 may attach to a manifold 117 that splits the fan output into a number of necessary runs, such as four duct runs 120 shown in FIGS. 2 and 3. In use with a 2000 cfm fan, 5-700 cfm per 50 foot run currently yields desirable results although more testing may optimize these findings.

Within the fan 110, reducer 115, manifold 117, or duct run 120 (though less desirable if using polyethylene), there may be an air purifier such as that shown by U.S. Pat. No. 8,585,979, which is incorporated by reference as if fully set forth herein. Such a purifier may be suited to large plant husbandry facilities.

Other air purifier sand/or passive air filter (neither shown but well known to those of skill in the art) may also be used. The air purifier may be of the UV light variety where it may be important to block ambient light from escaping the purification area as this light may adversely affect plant growth. One advantage of the UV and/or passive purification system is that it can replace a separate air purification system usually used in plant husbandry facilities. Thus, not only does the system described herein promote airflow under a canopy and reduce plant damage in that way, it also saves a horticulturalist money from having to buy and maintain a separate air purification system.

While the invention has been described with reference to the embodiments above, a person of ordinary skill in the art would understand that various changes or modifications may be made thereto without departing from the scope of the claims.

1. A system for promoting airflow beneath a plant canopy in a plant husbandry facility comprising:
a fan that creates an airflow; and
a duct row in fluid communication with the fan and receives the airflow, wherein the duct row has holes therein, wherein the holes are oriented to direct airflow from the fan out of the holes upwards under the plant canopy.

2. The system of claim 1, further comprising multiple duct rows in fluid communication with the fan.

3. The system of claim 2, further comprising a manifold located between the fan and the multiple duct rows, wherein the manifold directs airflow from the fan into each of the multiple duct rows.

4. The system of claim 1, further comprising a reducer located between the fan and the duct row.

5. The system of claim 1, wherein the holes are aligned in a line.

6. The system of claim 5, wherein there are multiple lines of holes.

7. The system of claim 1, wherein the holes direct airflow across and/or under plant roots.

8. The system of claim 1, wherein the duct row comprises two tubes of polyethylene having the holes, and wherein the airflow is directed through the holes when the two tubes holes are aligned with one another.

9. The system of claim 1, wherein airflow is subject to UV purification.

10. The system of claim 1, wherein the plant canopy is provided by cannabis plants.

11. A method of promoting airflow beneath a plant canopy in a plant husbandry facility comprising:
providing a source of consistent airflow; and
directing the airflow through a duct row having holes therein, wherein the holes are oriented to direct airflow upwards under the plant canopy.

12. The method of claim 11, further comprising directing the airflow through multiple duct rows.

13. The method of claim 11, wherein the holes are aligned in a line.

14. The method of claim 13, wherein there are multiple lines of holes.

15. The method of claim 11, wherein the holes direct airflow across and/or under plant roots.

16. The method of claim 11, wherein the duct row comprises two tubes of polyethylene having the holes, and wherein the airflow is directed through the holes when the two tubes holes are aligned with one another.

17. The method of claim 11, further comprising purifying the airflow using UV purification.

18. The method of claim 11, wherein the plant canopy is provided by cannabis plants.
